(19) United States
(12) Patent Application Publication
(10) Pub. No.: US 2012/0050016 A1
(43) Pub. Date: Mar. 1, 2012

(54) Method and System for Determining the Distance, Speed, and/or Direction of Movement of an RFID Transponder

(76) Inventors: Robert Bieber, Dresden (DE); Daniel Evers, Otterfing (DE); Dieter Horst, Cadolzburg (DE); Gerhard Metz, Munchen (DE); Stefan Schwarzer, Taufkirchen (DE); Claus Seisenberger, Neufrannhofen (DE)

(21) Appl. No.: 13/148,915

(22) PCT Filed: Sep. 10, 2009
(86) PCT No.: PCT/EP2009/061729

§ 371 Date: Nov. 9, 2011

(30) Foreign Application Priority Data
Feb. 10, 2009 (DE) 10 2009 008 174.7

(51) Int. Cl. G08B 13/14

(52) U.S. Cl. 340/10.1

(57) ABSTRACT

A method and a system for determining the distance, speed, and/or direction of movement of a radio frequency identification (RFID) transponder, wherein a RFID reading device transmits a power supply carrier signal that is modulated during some phases to interrogate the RFID transponder. A radar module simultaneously transmits a radar signal that is received and reflected by the RFID transponder. The reflected radar signal is re-received by the radar module. The position of the RFID transponder can be determined from the reflected, received radar signal. The radar signal is transmitted especially when no interrogation data is modulated onto the power supply carrier signal, where the power supply carrier signal and the radar signal have different frequencies.

### CROSS-REFERENCE TO RELATED APPLICATIONS

This is a U.S. national stage of application No. PCT/EP2009/061729 filed 10 Sep. 2009. Priority is claimed on German Application No. 10 2009 008 174.7 filed 10 Feb. 2009, the content of which is incorporated herein by reference in its entirety.

### BACKGROUND OF THE INVENTION

1. Field of the Invention

Radio Frequency IDentification (RFID) technology is now widely known and has developed rapidly in recent years. Specifically the favorable passive ultra-high-frequency (UHF) RFID transponders, such as RFID labels or RFID tags, are now found in very large quantities on the market. RFID transponders simplify operational flows in logistics and in industry. Thus, an RFID transponder (or “transponder”) in conjunction with an RFID reading device (or “reading device”) is employed in all kinds of application domains, such as inventory management or for identification purposes in the security-systems field. Their main functions are to be found in providing a unique identification number and in generally accepting a small quantity of data.

A transponder, which generally has at least one antenna and a chip having a backscatter-modulator, a sequential logic system, and a data memory, is interrogated and/or read out with the aid of electromagnetic waves in accordance with the backscatter principle that is known per se. Here, the reading device transmits a constant, evenly modulated signal which, on the one hand, causes an RFID chip integrated in the transponder to emit a response signal that in turn is registered by the reading device. The response signal contains at least one unique transponder identifier and, where applicable, other data. The signal emitted by the reading device can, on the other hand, be used also for supplying the transponder with power.

A transponder is irradiated by the reading device usually at the operating frequency with an electromagnetic signal that is received by a transponder antenna and converted by a rectifier for use. The signal emitted by the reading device consists of a power-supply carrier signal, i.e., a carrier, onto which data possibly requiring to be transmitted to the transponder is modulated in a known manner. For example, a request can be made thereby by the reading device to deliver the transponder's identification number or read out the transponder's memory. The carrier will not, though, be switched off immediately after the data has been transmitted because the transponder would otherwise be without power and unable to respond. The carrier will instead be maintained unmodulated and the transponder will change its antenna's reflectance factor to backscatter modulation. As a result, the transponder will be able to send the reading device its response virtually without power. The transponder's energy supply is the critical path with that kind of communication, i.e., the transponder's response would be detectable at an even greater distance. However, the power consumption of modern transponders limits the range to at most around 10 m.

What is widely practiced is to employ the Industrial, Scientific, and Medical (ISM) band at 868 MHz in Europe or at 915 MHz in the USA. The maximum reading range is not greater than 10 m when signals are emitted at the highest permitted transmitter power. Overreaching is a problem in operating RFID systems in the UHF band that can occur especially in closed spaces. Thus, a transponder a long way from the reading device can, due to design-related interference from the electromagnetic waves emitted by the reading device, be supplied with power and identified despite actually being outside the reading device's specified range. The overreaching could be recognized as such through measuring the distance between the reading device and transponder.

Measuring the transponder's distance, speed, and/or direction of movement is of great interest in general apart from this specific instance.

It is known that distance measuring with a sufficiently high resolution requires a large bandwidth for the signals used for performing the measurement. A radar system's resolution capacity R is calculated according to R=c/B, where c is the speed of light and B is the electromagnetic signal's bandwidth. For example, a Frequency-Modulated Continuous Wave (FMCW) radar having a bandwidth B=80 MHz offers a resolution capacity of R=1.875 m. That is, signal propagating over indirect paths, for example, through reflecting on a room's walls, with path differences of less than 1.875 m can seriously falsify the measurement result. It is only when path differences are greater that the multiple paths can be separated from distance estimating and will account for only a slight error. If proceeding from a line-of-sight (LOS) situation, in which the direct line-of-sight between the reading-device and transponder antennas is undisrupted, then the error due to multiple paths can in most measuring environments be minimized to an amount below R/10, which in the case of the radar presented by way of example would mean an error of an order of magnitude not exceeding 20 cm. If, though, the direct LOS is obscured, a much greater error will be likely.

In a customary RFID system, the bandwidth of the backscatter-modulated response signal is at most 500 kHz. That results in a resolution capacity of R=300 m and a residual error of approximately R/10=30 m. In combination with the RFID system's already mentioned range of only 10 m, it is immediately apparent that this assumable error will render distance measuring virtually impossible. This measuring difficulty could be remedied by combining a plurality of distance measurements performed at different mid-frequencies, although only a very limited bandwidth of approximately 2 MHz is available for UHF RFID systems in Europe and 15 MHz in the USA at the frequencies indicated.

Another possibility for determining the transponder's direction of movement and speed is to use what are termed gates. Gates, referred to also as gate readers, are like doorways and passages that contain antennas to which an RFID reading device is connected. A person wishing to identify an item fitted with a transponder will pass the item through such a gate. Provided therein are a plurality of reading devices that are spaced far apart and register a transponder's successful identification. The temporal sequence of the identifications allows the transponder's direction of movement and speed to be inferred. The transponder's exact position and speed between the gates will remain unknown, however. Overreaching can also produce false information here, such as when a transponder has not passed through a gate at all but has only been unfavorably near the gate.

Another way to at least partially avoid overreaching is to employ special antennas and reading devices that are finely tuned in terms of transmitter power. However, the problem of overreaching cannot be completely eliminated even when this method is applied.

### SUMMARY OF THE INVENTION

It is therefore an object of the present invention to provide a method and device for determining the position of an RFID transponder.

This and other objects and advantages are achieved by providing a method for determining a position of an RFID transponder configured to receive and reflect a power-supply carrier signal emitted by an RFID reading device at an RFID frequency and a radar signal emitted by a radar module at a radar frequency, where the radar module irradiates the RFID transponder with the radar signal, the radar signal is reflected by the RFID transponder and the reflected radar signal is received on the radar module, and the position of the RFID transponder is determined from the reflected radar signal received on the radar module.

The transponder's “position” requiring to be determined can be a 1-dimensional, 2-dimensional or 3-dimensional quantity. As a 1-dimensional quantity the position would correspond simply to a distance between the transponder and a reference point which can be, for instance, the reading device.

The present invention exploits the fact that particularly for cost reasons the transponder chip of an RFID transponder in which, for example, backscatter modulation is performed will be designed not on a narrowband basis for just one specific operating frequency but on a relatively broadband basis. As a result, only one chip variant will have to be developed that can be used, for example, for transponder labels of different regions, such as Europe, the USA and Asia. It is more favorable also from a technical view point not to explicitly restrict the backscatter modulator in its frequency response. It can thus be assumed that the backscatter modulator in the transponder chip will even in the presence of a—particularly higher—frequency that differs from the selected RFID operating frequency make a sufficiently large change in its reflectance factor available to be able to benefit from the chip's backscatter functionality also at higher frequencies.

Proceeding from that basis, the present invention builds on the fact that an RFID transponder whose position and possibly whose speed and/or direction of movement is/are to be determined will be irradiated not just by the reading device with the corresponding interrogation signal having a typical RFID operating frequency but ideally simultaneously by at least one radar module with a corresponding radar signal having a large bandwidth and a frequency differing from the RFID operating frequency.

With the inventive method for determining a position of an RFID transponder configured to receive and reflect a power-supply carrier signal emitted by an RFID reading device at an RFID frequency and a radar signal emitted by a radar module at a radar frequency, the RFID transponder is irradiated by the radar module with the radar signal. The radar signal is thereupon reflected by the RFID transponder and the reflected radar signal is received on the radar module. The RFID transponder's position can now be determined from the reflected radar signal received on the radar module.

Preferably, the radar signal is emitted simultaneously with the power-supply carrier signal.

Interrogation data for interrogating and/or reading out the transponder is modulated in phases onto the power-supply carrier signal. The radar signal will therein be emitted only if no data is modulated onto the power-supply carrier signal.

In an embodiment, the radar signal is emitted as soon as the interrogation data has finished being modulated onto the power-supply carrier signal.

In a preferred embodiment, the power-supply carrier signal and radar signal have different frequencies. The radar signal's bandwidth is moreover larger than that of the power-supply carrier signal.

A speed and/or direction of movement of the RFID transponder will furthermore advantageously be determined alongside its position from the reflected radar signal received on the radar module.

The radar signal will be modulated, i.e., backscatter-modulated, in the RFID transponder prior to reflecting, with data that at least includes an identification number of the RFID transponder and/or contents of a data memory of the RFID transponder being modulated onto the radar signal during modulating. The thus modulated reflected signal is received in the radar module and evaluated in terms of the data modulated onto the signal. The interrogation data can hence also be ascertained independently of the RFID reading device.

The object of the invention is also achieved by an arrangement for determining a position of an RFID transponder including a radar module for emitting a radar signal at a radar frequency. The RFID transponder is configured to receive and reflect the emitted radar signal and a power-supply carrier signal emitted by an RFID reading device at an RFID frequency. The radar module is for its part is configured to receive the radar signal reflected by the RFID transponder. The arrangement furthermore has an evaluation device linked to the radar module for determining the RFID transponder's position using the received, reflected radar signal.

The RFID reading device and radar module are advantageously permanently joined to each other and in particular share a housing. As a result, a compact device is achieved by which precise measuring of the transponder's position is possible alongside identifying the transponder.

The power-supply carrier signal and radar signal furthermore have different frequencies and the radar signal's bandwidth is larger than that of the power-supply carrier signal.

The RFID transponder advantageously has a modulator, i.e., a backscatter modulator, which is configured to modulate data that includes an identification number of the RFID transponder and/or contents of a data memory of the RFID transponder onto the radar signal prior to reflecting. The evaluation device is configured to evaluate the modulated, reflected radar signal in terms of the data modulated onto it. What is achieved thereby is that data can be modulated not only onto the RFID signal but also onto the radar signal. The radar module can hence be used both for measuring the position of the transponder and identifying the transponder.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantages, features, and specifics of the invention emerge from the exemplary embodiment described below as well as with the aid of the drawings, in which:

FIGS. 1A and 1B therein show the temporal sequence of the inventive distance measuring.

### DETAILED DESCRIPTION OF THE PREFERRED EMBODIMENTS

Regions, components, component groups, and steps of the method that are identical or mutually corresponding have been assigned the same reference numerals in the figures.

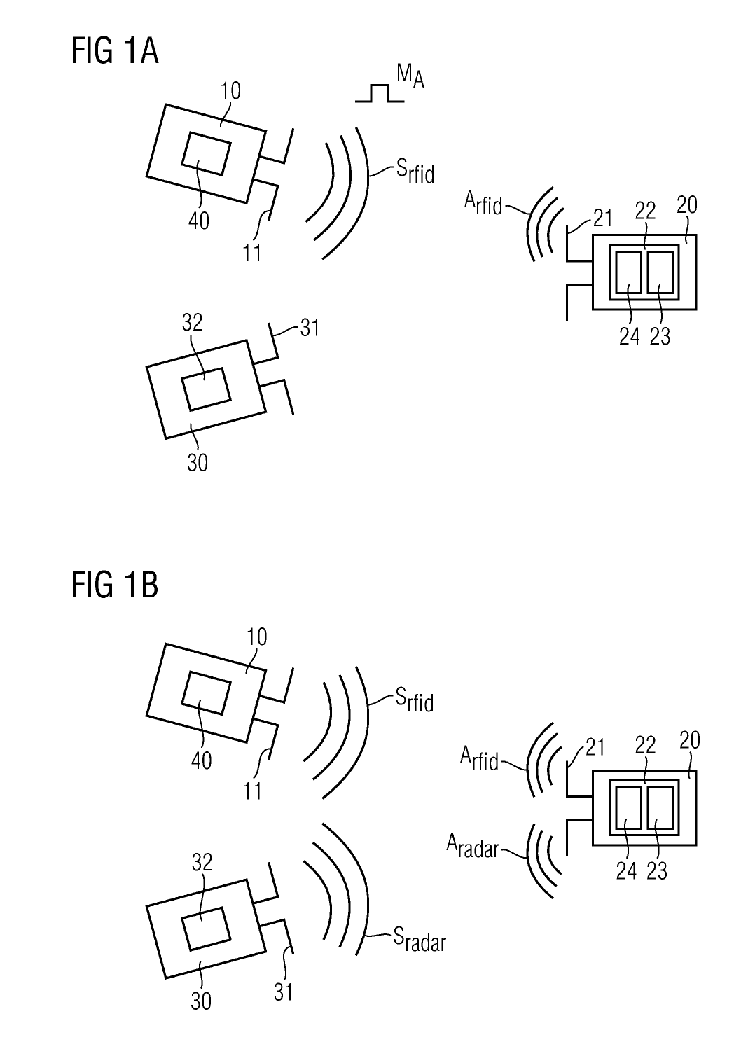

Shown in FIG. 1A are an RFID reading device 10, an RFID transponder 20 and a radar module 30, each having an antenna 11, 21, 31. The position, speed, and direction of movement of transponder 20 are to be ascertained. Provided in reading device 10 is a computer 40 and, alongside antenna 21, transponder 20 has a transponder chip 22 having a data memory 23 and a backscatter modulator 24. Radar module 30 has an evaluation device 32.

Reading device 10 makes a power-supply carrier signal S_{rfid} available, for example, at an RFID operating frequency of f_{rfid}=868 MHz and modulates, where applicable, interrogation data M_{A} onto the carrier signal S_{rfid} to interrogate an identification number of transponder 20 and to read out the contents of memory 23 of transponder 20. Interrogation data M_{A} is modulated onto the power-supply carrier signal S_{rfid} only in phases, i.e., in a temporally not uninterrupted manner, meaning the power-supply carrier signal S_{rfid} will in part be emitted also in non-modulated fashion.

An operating frequency of, for example, f_{rfid}=915 MHz can alternatively also be selected. Transponder 20 is supplied with energy by power-supply carrier signal S_{rfid}, awakes and demodulates the request. Those processes are to that extent sufficiently known.

The situation is shown in FIG. 1B at a later instant at which data has stopped being transmitted from reading device 10 to transponder 20, so when no further interrogation data M_{A} is being modulated onto carrier signal S_{rfid}. The non-modulated power-supply carrier S_{rfid} continues being transmitted, though, in order to supply transponder 20 with power so that back-scatter modulating, performed by backscatter modulator 24 of transponder 20, and hence response A_{rfid} by transponder 20 is made possible. Radar module 30 simultaneously irradiates transponder 20 with a broadband electromagnetic signal S_{radar} to determine the transponder's distance, speed, and direction of movement.

Reading device 10 receives backscatter-modulated response signal A_{rfid} of transponder 20 and evaluates it in a known manner in keeping with the requested data, such as identification number and contents of memory 23 of transponder 20.

In accordance with the invention, while transponder 20 is using its backscatter modulator 24 to send response signal A_{rfid} to reading device 10, transponder 20 is simultaneously irradiated with signal S_{radar} of radar module 30. Radar frequency f_{radar} of radar signal S_{radar} therein differs from RFID frequency f_{rfid}=868 MHz of power-supply carrier S_{rfid}. For example, it is possible here to use a signal S_{radar} from the ISM band having a mid-frequency of f_{radar}=2.45 GHz and a bandwidth of B_{radar}=80 MHz. The 5.8-GHz ISM band having a bandwidth B_{radar} of approximately 150 MHz is likewise suitable. In selecting a frequency range for distance measuring with the aid of radar module 30, it is fundamentally decisive for a frequency range to be selected in the case of which as high as possible a bandwidth is available.

Radar signal S_{radar} is reflected as is power-supply carrier signal S_{rfid} by transponder 20 and finally returns to radar module 30 where it is received in the form of a response signal S_{radar}. Using customary radar-technology methods (as explained below), the required measured values, i.e., the position, speed, and/or direction of movement of transponder 20, can then be determined with a low error factor owing to the high bandwidth B_{radar} in an evaluation device 32 belonging to radar module 30 from radar signal A_{radar} reflected by transponder 20.

It must be noted therein that the reference point for measuring the position, speed, and direction of movement is no longer antenna 11 of reading device 10 but antenna 31 of radar module 30. An appropriate conversion must be performed to refer the measured values of radar module 30 to reading device 10. Reading device 10 is typically linked to a computer 40 on which suitable software, for example, middleware, has been installed. The measured values ascertained by radar module 30 are transmitted over, for example, a radio link to computer 40, where the measured values in relation to reading device 10 are finally computed. Computer 40 can be integrated in a housing of reading device 10. It is alternatively possible to use a central computer (not shown) that communicates with reading device 10 over a radio link. What suggests itself in the latter case is for radar module 30 also to communicate with computer 40 over a radio link to transmit the measured values to computer 40. The cited conversions into measured values referred to reading device 10 can, where applicable, then take place in computer 40. It is conceivable also for the aforementioned evaluation device 32 belonging to radar module 30 to be realized by the central computer 40 so that no data processing takes place in radar module 30 itself and the process of actually determining the measured values “position”, “speed”, and/or “direction of movement” is relocated to computer 40.

Radar module 30 and reading device 10 can furthermore be permanently joined to each other by sharing a housing, for example. It can in that case be assumed that the position of transponder 20 that is determined by means of radar module 30 and refers initially only to radar module 30 can be equated with a position of transponder 20 referred to reading device 10.

A customary radar-technology method for determining the spacing or distance between radar module 30 and transponder 20 is, for example, to measure the propagation time, while the speed of transponder 20 can be determined with the aid of a Doppler measurement or by the change in distance over time. The direction of movement can likewise be ascertained by a Doppler measurement, with it being necessary to evaluate only the sign of the Doppler shift. The direction of movement can be determined also by the change in distance over time. Other methods for ascertaining the measured values “distance”, “speed” and “direction of movement” can of course also be used and will be well known to a person skilled in the relevant art.

Like the carrier signal S_{rfid}, radar signal S_{radar} emitted by radar module 30 and received on transponder 20 is also modulated by backscatter modulator 24 prior to reflecting. Signal A_{radar} reflected by transponder 20 and in turn received on radar module 30 is accordingly a backscatter-modulated signal on the basis of which for example the identification number of transponder 20 and the contents of memory 23 of transponder 20 can be ascertained also on radar module 30. Backscatter modulating of the radar signal in particular makes transponder 20 stand out from what are termed passive radar objectives such as walls, ceilings, steel girders, goods and/or persons and allows it to be clearly visible in the receive signal of radar module 30.

It is likewise advantageous that radar module 30 can be used not merely for ascertaining the measured values but also for demodulating the data sent by transponder 20 through backscatter modulating. Radar module 30 can, for example, receive the identification number of transponder 20 and link the ascertained distance etc. to the identification number. That is highly advantageous in a decentralized system in which reading device 10 and one or even more radar module(s) 30 are arranged in a spatially distributed manner because the measured quantity can then for a unique assignment be provided with the identification number of transponder 20. Reading device 10 can also be simplified in its functionality such that it will only provide power-supply carrier S_{rfid} at operating frequency f_{rfid} and modulate the request onto it, while the processes of receiving and evaluating the backscattered data are completely relocated to radar module 30. A large number of favorable reading devices serving merely to supply the transponders with power would hence be conceivable. Identifying of transponder 20 can alternatively also occur in reading device 10, while evaluating the backscatter-modulated response of transponder 20 can also occur in radar module 30 alongside determining the position, speed and/or direction of movement of transponder 20. Reading device 10 would in that embodiment only have the function of providing or emitting the power-supply carrier signal S_{rfid} modulated in phases with interrogation data and the function of identifying transponder 20.

A special embodiment of backscatter modulating is advantageous for evaluating reflected radar signal A_{radar} in radar module 30. The data requiring to be conveyed by transponder 20 to reading device 10 is usually encoded before being emitted, with encoding methods FMO, Miller and Manchester being customary. It is therein ensured that, for example, the emission of a “000000000” bit sequence will not mean that backscattering never changes over because a response of such kind would be undetectable. The encoding methods therefore make sure that the backscatter modulator has a mean changeover frequency that varies in cadence with the bit sequence. Varying of the changeover frequency will then constitute the bit sequence requiring to be transmitted and can be detected in reading device 10. It is especially advantageous for radar module 30 if the backscatter-modulation frequency is constant. That can be achieved by writing a bit sequence into memory area 23 of transponder 20 before distance measuring, the reading out of which sequence will result in backscatter modulating at a constant frequency.

Whereas transponder chip 22 is, as mentioned, as a rule of broadband design, antenna 21 of transponder 20 will not have been optimized for a frequency range differing from RFID operating frequency f_{rfid}. For optimizing the maximum measuring distance, it may accordingly be necessary to match antenna 21 for employing the backscatter method at higher frequencies by, for example, matching the antenna impedance to the chip such that the desired backscatter signal will have an optimal strength.

Using a plurality of radar modules that operate according to the above-described method and additionally advantageously either at different operating frequencies, i.e., in the frequency-division multiplex mode, or alternating over time, i.e., in the time-division multiplex mode, allows different accuracies to be realized by different bandwidths and different measuring ranges to be realized by different operating frequencies. The transponder can also be located multi-dimensionally if the radar modules are arranged in a spatially distributed manner.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested from or embodiment as a general matter of design choice.

1.-11. (canceled)

12. A method for determining a position of a radio frequency identification (RFID) transponder configured to receive and reflect a power-supply carrier signal emitted by an RFID reading device at an RFID frequency and a radar signal emitted by a radar module at a radar frequency, the method comprising:
irradiating, by the radar module, the RFID transponder with the radar signal;
reflecting, by the RFID transponder, the radar signal;
receiving the reflected radar signal on the radar module; and
determining the position of the RFID transponder from the reflected radar signal received by the radar module.

13. The method as claimed in claim 12, wherein the radar signal is emitted simultaneously with the power-supply carrier signal.

14. The method as claimed in claim 12, wherein interrogation data for at least one of interrogating and reading out the RFID transponder is modulated in phases onto the power-supply carrier signal, the radar signal being emitted only if no data is modulated onto the power-supply carrier signal.

15. The method as claimed in claim 13, wherein interrogation data for at least one of interrogating and reading out the RFID transponder is modulated in phases onto the power-supply carrier signal, the radar signal being emitted only if no data is modulated onto the power-supply carrier signal.

16. The method as claimed in claim 14, wherein the radar signal is emitted as soon as the interrogation data has finished being modulated onto the power-supply carrier signal.

17. The method as claimed in claim 12, wherein the power-supply carrier signal and radar signal have different frequencies; and wherein a bandwidth of the radar signal is larger than a bandwidth of the power-supply carrier signal.

18. The method as claimed in claim 12, further comprising:
determining at least one of a speed and direction of movement of the RFID transponder from the reflected radar signal received on the radar module.

19. The method as claimed in claim 12, wherein the radar signal is modulated in the RFID transponder prior to reflecting, with data that includes at least one of an identification number of the RFID transponder and contents of a data memory of the RFID transponder being modulated onto the radar signal; and wherein the modulated reflected radar signal is received in the radar module and the data modulated onto the signal is evaluated.

20. The method of claim 19, wherein the radar signal is backscatter-modulated in the RFID transponder prior to reflecting the radar signal.

21. An arrangement for determining a position of a radio frequency identification (RFID) transponder, comprising:
a radar module configured to emit a radar signal at a radar frequency and receive a radar signal reflected by the RFID transponder; and
an evaluation device linked to the radar module and configured to determine the position of the RFID transponder using the received, reflected radar signal;
wherein the RFID transponder is configured to receive and reflect both the emitted radar signal and a power-supply carrier signal emitted by an RFID reading device at an RFID frequency.

22. The arrangement as claimed in claim 20, wherein the RFID reading device and radar module are permanently joined to each other.

23. The arrangement as claimed in claim 21, wherein the power-supply carrier signal and radar signal have different frequencies; and wherein a bandwidth of the radar signal is greater than a bandwidth of the power-supply carrier signal.

24. The arrangement as claimed in claim 21, wherein the RFID transponder comprises a modulator configured to modulate data including at least one of an identification number of the RFID transponder and contents of a data memory of the RFID transponder onto the radar signal prior to reflecting the radar signal, and wherein the evaluation device is configured to evaluate the modulated, reflected radar signal based on the data modulated onto the radar signal.

25. The arrangement as claimed in claim 21, wherein the RFID reading device and radar module are permanently joined to each other by a shared housing.

26. The arrangement as claimed in claim 24, wherein the a modulator comprises a backscatter modulator.
